(19) United States
(12) Patent Application Publication
(10) Pub. No.: US 2009/0102077 A1
(43) Pub. Date: Apr. 23, 2009

(54) Method for Manufacturing Light Guide

(76) Inventor: Wen-Hsiu Hung, Waipu Township (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/968,303

(22) Filed: Jan. 2, 2008

(30) Foreign Application Priority Data
Oct. 18, 2007 (TW) 096139017

(51) Int. Cl. B29D 11/00

(52) U.S. Cl. 264/1.29

(57) ABSTRACT

A method for manufacturing a light guide includes providing a roll unit, enclosing a metallic film around the roll unit wherein the metallic film has a plurality of micro-protrusions, driving a light guide film to pass through the roll unit to form a plurality micro-indentations on the light guide film, and cutting the light guide film to have a determined size to form a light guide. Thus, the light guide is made by hot rolling so that the light guide is made easily and quickly. In addition, only the surface of the light guide film is heated and softened so that after the light guide film is hot rolled by the roll unit, the light guide film is cooled and solidified quickly to prevent the light guide film from being deformed due to an excessive heat.

### BACKGROUND OF THE INVENTION

1. Field of the Invention

The present invention relates to a method for manufacturing a light guide and, more particularly, to a method for manufacturing a light guide of a backlight module.

2. Description of the Related Art

A light guide is a primary element of a backlight module which is used for an LCD. A conventional method for manufacturing a thin-shaped light guide comprises melting a plastic material into a liquid state by an injection molding machine, and filling the liquid plastic material into a mold to form a light guide so that the light guide has a determined shape and has a surface provided with a plurality of patterns or micro-indentations. The light guide can diffuse light beams by the patterns or micro-indentations. Thus, the light guide is used to guide the transmission direction of the light beams to transform a line or spot light source into a planar light source and emit the planar light source outwardly. In fabrication of the light guide, the mold is made. Then, a pattern is formed on a core (or stamper). Then, the pattern is inserted into the mold. Then, the mold is set on the injection molding machine. Then, the plastic material is treated by dehumidifying, drying and softening processes during six to eight hours. Then, the plastic material is conveyed into a storage container of the injection molding machine. Then, the particles of the plastic material are melted by a high temperature in the injection molding machine. Then, the melted plastic material is filled into the mold and is shaped in the mold at a high pressure. Then, the mold is opened to remove the plastic material from the mold. Then, the plastic material is cut to form the light guide.

However, the conventional method for manufacturing a light guide has a complicated procedures, so that the light guide is not made easily and quickly, thereby increasing the costs of fabrication, and thereby decreasing the productivity. In addition, when a light guide having a larger size is injected, the melted plastic material cannot be filled into the die cavity evenly, so that the light guide having a larger size is not made easily and quickly. Further, after the melted plastic material is formed and cooled after the injection molding process, the thin-shaped light guide is deformed or curved easily, thereby decreasing the quality of the light guide.

### BRIEF SUMMARY OF THE INVENTION

In accordance with the present invention, there is provided a method for manufacturing a light guide, comprising providing a roll unit, enclosing a metallic film around the roll unit wherein the metallic film has a periphery provided with a plurality of micro-protrusions, driving a light guide film to pass through the roll unit to form a plurality micro-indentations on a surface of the light guide film by pressing of the micro-protrusions of the metallic film, and cutting the light guide film to have a determined size to form a light guide.

The primary objective of the present invention is to provide a method for manufacturing a light guide, wherein the light guide is made by hot rolling so that the light guide is made easily and quickly, thereby decreasing the costs of fabrication, and thereby increasing the productivity.

Another objective of the present invention is to provide a method for manufacturing a light guide, wherein the light guide is made by hot rolling so that the specification and size of the light guide will not be limited.

A further objective of the present invention is to provide a method for manufacturing a light guide, wherein only the surface of the light guide film is heated and softened so that after the light guide film is hot rolled between the two rolls of the roll unit, the light guide film is cooled and solidified quickly to prevent the light guide film from being deformed due to an excessive heat.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a front view showing an apparatus for performing a method for manufacturing a light guide in accordance with the preferred embodiment of the present invention.

FIG. 2 is a locally enlarged view of the apparatus as shown in FIG. 1.

FIG. 3 is a perspective view of a light guide film in accordance with the preferred embodiment of the present invention.

FIG. 4 is a front view showing an apparatus for performing a method for manufacturing a light guide in accordance with another preferred embodiment of the present invention.

FIG. 5 is a locally enlarged view of the apparatus as shown in FIG. 4.

### DETAILED DESCRIPTION OF THE INVENTION

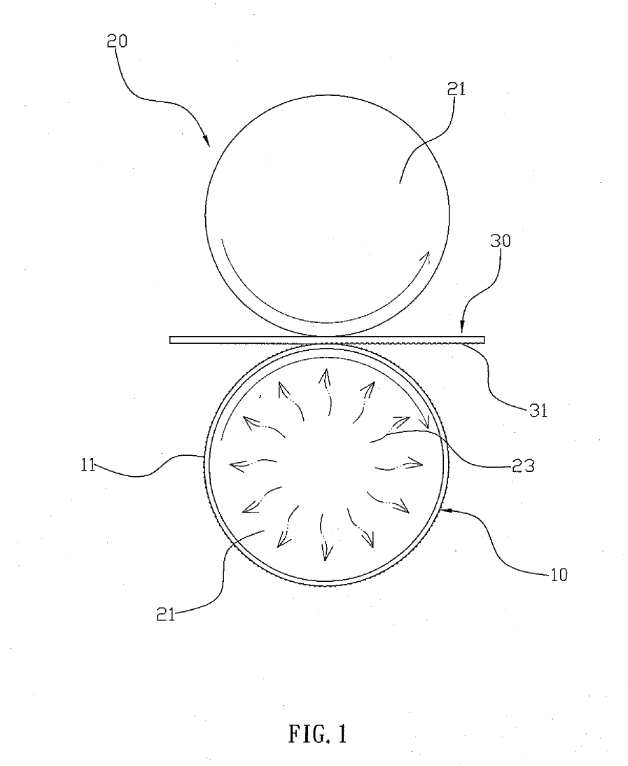

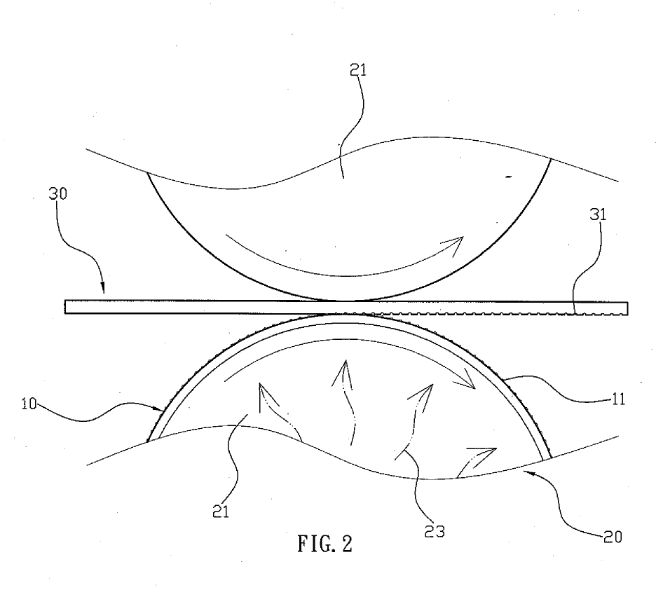

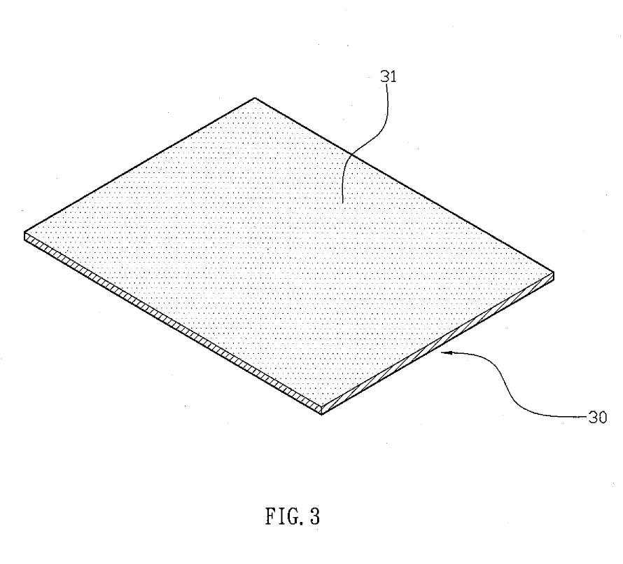

Referring to the drawings and initially to FIGS. 1-3, a method for manufacturing a light guide in accordance with the preferred embodiment of the present invention comprises providing a roll unit 20, enclosing a metallic film 10 around the roll unit 20 wherein the metallic film 10 has a periphery provided with a plurality of micro-protrusions 11 driving a light guide film 30 to pass through the roll unit 20 to form a plurality micro-indentations 31 on a surface of the light guide film 30 by pressing of the micro-protrusions 1 of the metallic film 10, and cutting the light guide film 30 to have a determined size to form a light guide which is available for a backlight module.

In fabrication of the metallic film 10, a photomask is made to simulate a pattern (or microstructure) that is required for an optical element. Then, the photomask is treated by etching to form a female die of the pattern. Then, the female die is treated by electro-casting to form the metallic film 10. Thus, the metallic film 10 mates with the female die so that the metallic film 10 has a periphery provided with a plurality of micro-protrusions 11. Then, the metallic film 10 is enclosed around the roll unit 20. In such a manner, when the light guide film 30 passes through the roll unit 20, the roll unit 20 performs a hot rolling process on the light guide film 30 so as to form a plurality micro-indentations 31 on the surface of the light guide film 30 by pressing of the metallic film 10.

In the preferred embodiment of the present invention, the roll unit 20 includes two rolls 21 spaced from each other, and one of the two rolls 21 of the roll unit 20 has an inside provided with a heat source 23. In addition, the metallic film 10 is enclosed around the one of the two rolls 21 of the roll unit 20, and the light guide film 30 is driven to pass between the two rolls 21 of the roll unit 20, so that the light guide film 30 is hot rolled between the two rolls 21 of the roll unit 20, and the micro-indentations 31 are formed on a side of the light guide film 30 by pressing of the micro-protrusions 11 of the metallic film 10.

In practice, the metallic film 10 is enclosed around the one of the two rolls 21 of the roll unit 20. Then, the distance between the two rolls 21 of the roll unit 20 is adjusted, and the temperature of the one of the two rolls 21 of the roll unit 20 is adjusted. Then, the light guide film 30 is driven to pass between the two rolls 21 of the roll unit 20, so that the surface of the light guide film 30 contacting the one of the two rolls 21 of the roll unit 20 is heated and softened by the heat source 23 in the one of the two rolls 21 of the roll unit 20, and the micro-indentations 31 are formed on a side of the light guide film 30 by pressing of the micro-protrusions 11 of the metallic film 10. Thus, the light guide can diffuse a light by the micro-indentations 31 of the light guide film 30.

In such a manner, only the surface of the light guide film 30 is heated and softened so that after the light guide film 30 is driven to pass between the two rolls 21 of the roll unit 20, the light guide film 30 is cooled and solidified quickly to prevent the light guide film 30 from being deformed due to an excessive heat.

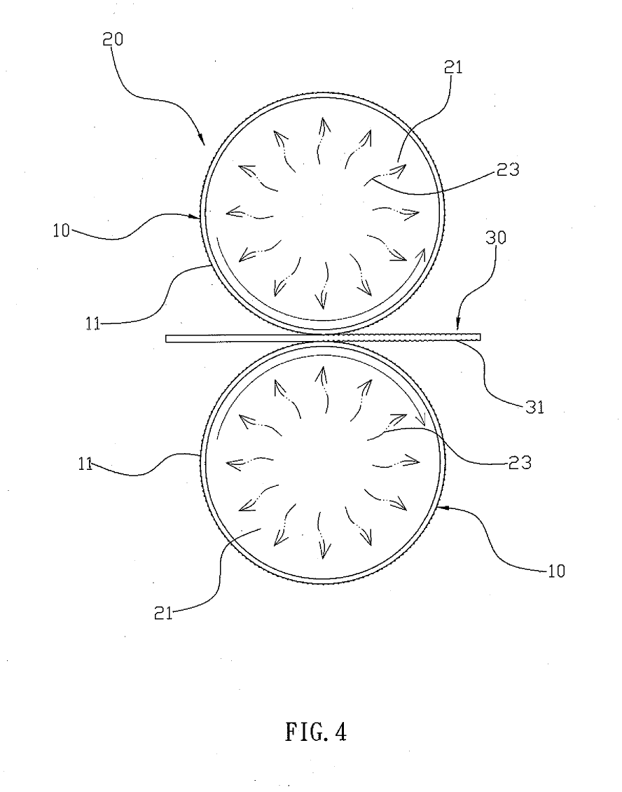

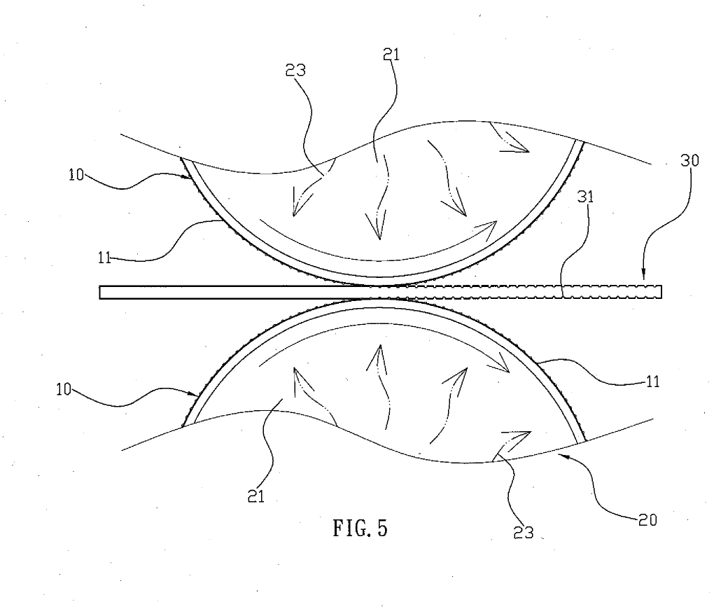

Referring to FIGS. 4 and 5, the roll unit 20 includes two rolls 21 spaced from each other, and each of the two rolls 21 of the roll unit 20 has an inside provided with a heat source 23. In addition, the metallic film 10 is enclosed around each of the two rolls 21 of the roll unit 20, and the light guide film 30 is driven to pass between the two rolls 21 of the roll unit 20, so that the light guide film 30 is hot rolled between the two rolls 21 of the roll unit 20, and the micro-indentations 31 are formed on each of two opposite sides of the light guide film 30 by pressing of the micro-protrusions 11 of the metallic film 10.

In the preferred embodiment of the present invention, the micro-indentations 31 of the light guide film 30 have a density and an arrangement that are changed by patterns of the photomask during the etching process. In addition, the two rolls 21 of the roll unit 20 and the metallic film 10 are expandable and contractible to correspond to a size of the light guide film 30 so as to directly form a light guide having a proper size by hot rolling.

Accordingly, the light guide is made by hot rolling so that the light guide is made easily and quickly, thereby decreasing the costs of fabrication, and thereby increasing the productivity. In addition, the light guide is made by hot rolling so that the specification and size of the light guide will not be limited. Further, only the surface of the light guide film 30 is heated and softened so that after the light guide film 30 is hot rolled between the two rolls 21 of the roll unit 20, the light guide film 30 is cooled and solidified quickly to prevent the light guide film 30 from being deformed due to an excessive heat.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A method for manufacturing a light guide, comprising:
providing a roll unit;
enclosing a metallic film around the roll unit wherein the metallic film has a periphery provided with a plurality of micro-protrusions;
driving a light guide film to pass through the roll unit to form a plurality micro-indentations on a surface of the light guide film by pressing of the micro-protrusions of the metallic film;
cutting the light guide film to have a determined size to form a light guide.

2. The method in accordance with claim 1, wherein in fabrication of the metallic film:
a photomask is made to simulate a pattern that is required for an optical element;
the photomask is treated by etching to form a female die of the pattern;
the female die is treated by electro-casting to form the metallic film;
the metallic film mates with the female die so that the metallic film has a periphery provided with a plurality of micro-protrusions.

3. The method in accordance with claim 1, wherein
the roll unit includes two rolls spaced from each other;
the metallic film is enclosed around one of the two rolls of the roll unit.

4. The method in accordance with claim 3, wherein the one of the two rolls of the roll unit has an inside provided with a heat source.

5. The method in accordance with claim 4, wherein
the light guide film is driven to pass between the two rolls of the roll unit;
the light guide film is hot rolled between the two rolls of the roll unit;
the micro-indentations are formed on a side of the light guide film by pressing of the micro-protrusions of the metallic film.

6. The method in accordance with claim 5, wherein
a distance between the two rolls of the roll unit is adjusted;
a temperature of the one of the two rolls of the roll unit is adjusted;
when the light guide film is driven to pass between the two rolls of the roll unit, the surface of the light guide film contacting the one of the two rolls of the roll unit is heated and softened by the heat source in the one of the two rolls of the roll unit, and the micro-indentations are formed on the side of the light guide film by pressing of the micro-protrusions of the metallic film.

7. The method in accordance with claim 6, wherein only the surface of the light guide film is heated and softened so that after the light guide film is hot rolled between the two rolls of the roll unit, the light guide film is cooled and solidified quickly to prevent the light guide film from being deformed due to an excessive heat.

8. The method in accordance with claim 1, wherein
the roll unit includes two rolls spaced from each other;
the metallic film is enclosed around each of the two rolls of the roll unit.

9. The method in accordance with claim 8, wherein each of the two rolls of the roll unit has an inside provided with a heat source.

10. The method in accordance with claim 9, wherein
the light guide film is driven to pass between the two rolls of the roll unit;
the light guide film is hot rolled between the two rolls of the roll unit;
the micro-indentations are formed on each of two opposite sides of the light guide film by pressing of the micro-protrusions of the metallic film.

11. The method in accordance with claim 10, wherein
a distance between the two rolls of the roll unit is adjusted;
a temperature of each of the two rolls of the roll unit is adjusted;
when the light guide film is driven to pass between the two rolls of the roll unit, the surface of the light guide film contacting the two rolls of the roll unit is heated and softened by the heat source in each of the two rolls of the roll unit, and the micro-indentations are formed on each of the two opposite sides of the light guide film by pressing of the micro-protrusions of the metallic film.

12. The method in accordance with claim 11, wherein only the surface of the light guide film is heated and softened so that after the light guide film is hot rolled between the two rolls of the roll unit, the light guide film is cooled and solidified quickly to prevent the light guide film from being deformed due to an excessive heat.

13. The method in accordance with claim 2, wherein the micro-indentations of the light guide film have a density and an arrangement that are changed by patterns of the photomask during the etching process.

14. The method in accordance with claim 1, wherein the two rolls of the roll unit and the metallic film are expandable and contractible to correspond to a size of the light guide film so as to directly form a light guide having a proper size by hot rolling.
